(19) United States
(12) Patent Application Publication
(10) Pub. No.: US 2008/0239556 A1
(43) Pub. Date: Oct. 2, 2008

(54) Linearizing position error signal using spiral servo information

(75) Inventors: James V. Wiseman, Palo Alto, CA (US); Gary W. Calfee, Santa Clara, CA (US)

Correspondence Address: SCHWEGMAN, LUNDBERG & WOESSNER, P.A., P.O. BOX 2938, MINNEAPOLIS, MN, 55402, US

(73) Assignee: TOSHIBA AMERICA INFORMATION SYSTEMS, INC.

(21) Appl. No.: 11/731,452

(22) Filed: Mar. 30, 2007

(51) Int. Cl. G11B 5/596

(52) U.S. Cl. 360/77.08

(57) ABSTRACT

A method for determining a position error signal in a disk drive includes writing a servo signal that has a variable offset from a track center for a plurality of concentric tracks in a servo wedge on a disk surface, forming a spiral servo track, observing the offset values for the servo signal in the servo wedges at a first of the plurality of tracks, and observing the offset values for the servo signal in the servo wedges at a second of the plurality of tracks. The method also includes determining the first error amounts from the offset values at the first of the plurality of tracks, and determining the second error amounts from the offset values at the second of the plurality of tracks. If the first error amounts and the second error amounts are equal, using one of the first or second error amounts as a correction update to a head non-linearity look-up table.

### TECHNICAL FIELD

Various embodiments described herein relate to apparatus, systems, and methods associated with information storage and processing. More specifically, the apparatus, systems and methods are for linearizing position error signal using spiral servo information in a disk drive.

### BACKGROUND

A disk drive is an information storage device. A disk drive includes one or more disks clamped to a rotating spindle, and at least one head for reading information representing data from and/or writing data to the surfaces of each disk. More specifically, storing data includes writing information representing data to portions of tracks on a disk. Data retrieval includes reading the information representing data from the portion of the track on which the information representing data was stored. Disk drives also include an actuator utilizing linear or rotary motion for positioning transducing head(s) over selected data tracks on the disk(s). A rotary actuator couples a slider, on which a transducing head is attached or integrally formed, to a pivot point that allows the transducing head to sweep across a surface of a rotating disk. The rotary actuator is driven by a voice coil motor.

Disk drive information storage devices employ a control system for controlling the position of the transducing head during read operations, write operations and seeks. The control system includes a servo control system or servo loop. The function of the head positioning servo control system within the disk drive information storage device is two-fold: first, to position the read/write transducing head over a data track with sufficient accuracy to enable reading and writing of that track without error; and, second, to position the write element with sufficient accuracy not to encroach upon adjacent tracks to prevent data erosion from those tracks during writing operations to the track being followed.

A servo control system includes a written pattern on the surface of a disk called a servo pattern. The servo pattern is read by the transducing head. Reading the servo pattern results in positioning data or a servo signal used to determine the position of the transducing head with respect to a track on the disk. In one servo scheme, positioning data can be included in servo wedges, each including servo patterns

### BRIEF DESCRIPTION OF THE DRAWINGS

The invention is pointed out with particularity in the appended claims. However, a more complete understanding of the present invention may be derived by referring to the detailed description when considered in connection with the figures, wherein like reference numbers refer to similar items throughout the figures and:

FIG. 1 is an exploded view of a disk drive that uses example embodiments described herein.

FIG. 2A is a partial detailed view of a disk from the disk drive shown in FIG. 1 that includes a spiral servo pattern, according to an example embodiment.

FIG. 2B is a graphic portrayal of the spiral servo pattern taken at representative locations within each revolution to yield a spiral servo pattern, according to an example embodiment.

FIG. 3 is a representation of a servo signal that is written as a continuous spiral around the disk, according to an example embodiment.

FIG. 4 is a schematic diagram of a disk drive and includes various electrical portions of the disk drive, according to an example embodiment.

FIG. 5 is a schematic diagram showing portions of the read/write path and a servo field detector of FIG. 4, according to an example embodiment.

FIG. 6 is a model of the disk drive system and an error source, according to an example embodiment.

FIG. 7 is a look-up table showing the effective position from track center as a function of the burst value, according to an example embodiment.

FIG. 8 is a model of the disk drive system and an error source, according to an example embodiment.

FIG. 9 is a flow diagram of a method for determining a position error signal in a disk drive, according to an example embodiment.

FIG. 10 is an example block diagram of a computer system for implementing functions and controllers described in accordance with example embodiments.

The description set out herein illustrates the various embodiments of the invention and such description is not intended to be construed as limiting in any manner.

### DETAILED DESCRIPTION

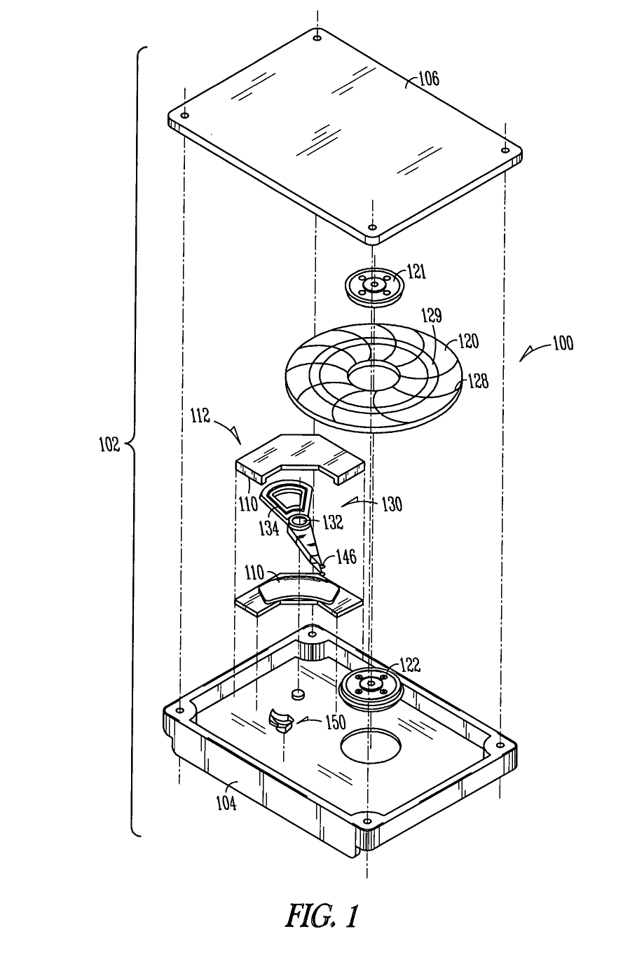

FIG. 1 is an exploded view of disk drive 100 that uses various embodiments of the present invention. The disk drive 100 includes a housing 102 including a housing base 104 and a housing cover 106. The housing base 104 illustrated is a base casting, but in other embodiments a housing base 104 can comprise separate components assembled prior to, or during assembly of the disk drive 100. A disk 120 is attached to a hub or spindle 122 that is rotated by a spindle motor. The disk 120 can be attached to the hub or spindle 122 by a clamp 121. The disk may be rotated at a constant or varying rate ranging from less than 3,600 to more than 15,000 revolutions per minute. Higher rotational speeds are contemplated in the future. The spindle motor is connected with the housing base 104. The disk 120 can be made of a light aluminum alloy, ceramic/glass or other suitable substrate, with magnetizable material deposited on one or both sides of the disk. The magnetic layer includes small domains of magnetization for storing data transferred through a transducing head 146. The transducing head 146 includes a magnetic transducer adapted to read data from and write data to the disk 120. In other embodiments, the transducing head 146 includes a separate read element and write element. For example, the separate read element can be a magneto-resistive head, also known as a MR head. It will be understood that multiple head 146 configurations can be used.

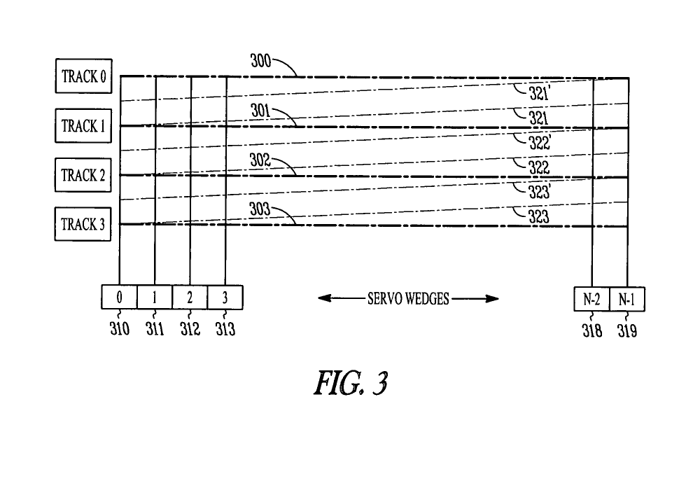

A rotary actuator 130 is pivotally mounted to the housing base 104 by a bearing 132 and sweeps an arc between an inner diameter (ID) of the disk 120 and a ramp 150 positioned near an outer diameter (OD) of the disk 120. Attached to the housing 104 are upper and lower magnet return plates 110 and at least one magnet that together form the stationary portion of a voice coil motor (VCM) 112. A voice coil 134 is mounted to the rotary actuator 130 and positioned in an air gap of the VCM 112. The rotary actuator 130 pivots about the bearing 132 when current is passed through the voice coil 134 and pivots in an opposite direction when the current is reversed, allowing for control of the position of the actuator 130 and the attached transducing head 146 with respect to the disk 120. The VCM 112 is coupled with a servo system (shown in FIG. 4) that uses positioning data read by the transducing head 146 from the disk 120 to determine the position of the head 146 over one of a plurality of tracks on the disk 120. The servo system determines an appropriate current to drive through the voice coil 134, and drives the current through the voice coil 134 using a current driver and associated circuitry (not shown in FIG. 1).

Each side of a disk 120 can have an associated head 146, and the heads 146 are collectively coupled to the rotary actuator 130 such that the heads 146 pivot in unison. The invention described herein is equally applicable to devices wherein the individual heads separately move some small distance relative to the actuator. This technology is referred to as dual-stage actuation (DSA).

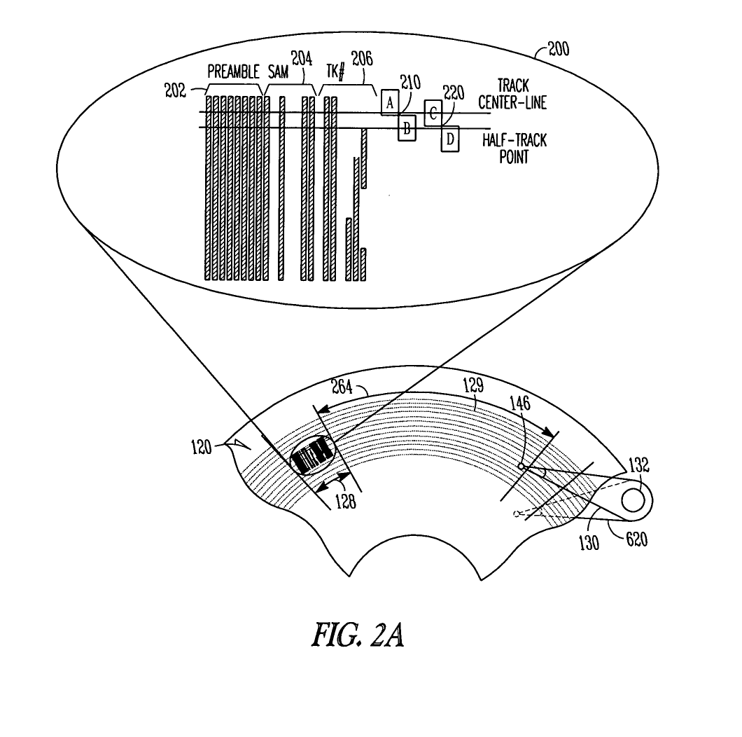

One type of servo system is an embedded, servo system in which tracks on each disk surface used to store information representing data contain small segments of servo information. The servo information, in some embodiments, is stored in radial servo sectors or servo wedges shown as several narrow, somewhat curved spokes 128 substantially equally spaced around the circumference of the disk 120. It should be noted that in actuality there may be many more servo wedges than as shown in FIG. 1. The servo wedges 128 are further detailed in FIGS. 2A and 2B and in the discussions associated with those FIGs.

The disk 120 also includes a plurality of tracks on each disk surface. The plurality of tracks is depicted by two tracks, such as track 129 on the surface of the disk 120. The servo wedges 128 traverse the plurality of tracks, such as track 129, on the disk 120. The plurality of tracks, in some embodiments, may be arranged as a set of substantially concentric circles. Data is stored in fixed sectors along a track between the embedded servo wedges 128. The tracks on the disk 120 each include a plurality of data sectors. More specifically, a data sector is a portion of a track having a fixed block length and a fixed data storage capacity (e.g. 512 bytes of user data per data sector). The tracks toward the inside of the disk 120 are not as long as the tracks toward the periphery of the disk 110. As a result, the tracks toward the inside of the disk 120 can not hold as many data sectors as the tracks toward the periphery of the disk 120. Tracks that are capable of holding the same number of data sectors are grouped into a data zones. Since the density and data rates vary from data zone to data zone, the servo wedges 128 may interrupt and split up at least some of the data sectors. The servo sectors 128 are typically recorded with a servo writing apparatus at the factory (called a servo-writer), but may be written (or partially written) with the disk drive's 100 transducing head 146 in a self-servowriting operation.

FIG. 2A shows a portion of a disk 120 having at least one servo wedge 128. Each servo wedge 128 includes information stored as regions of magnetization or other indicia, such as optical indicia. A servo wedge 128 can be longitudinally magnetized or alternatively perpendicularly magnetized. Servo patterns 200 contained in each servo wedge 128 are read by the transducing head 146 as the surface of the spinning disk 120 passes under the transducing head 146.

The magnified portion of FIG. 2A illustrates one example servo pattern 200 that is written as a spiral, such as a continuous spiral. The servo pattern 200 includes a set of servo bursts. As shown in FIG. 2, the set of servo bursts include an A servo burst, a B servo burst, a C servo burst, and a D servo burst. There is a servo burst edge 210 between the A burst and the B burst, and a servo burst edge 220 between the C burst and the D burst. The pattern shown is a quadrature type pattern. There are other burst patterns that could be used in other embodiments. In some embodiments, a disk drive will include a single column of each type of servo burst in each servo wedge 128. The servo patterns 200 can include information identifying a data sector contained in a data field 264. For example, the servo pattern 200 can include digital information such as a preamble 202, a servo address mark (SAM) 204, a track identification number 206. The servo pattern 200 may also include a first phase burst servo pattern 210 that is written as a single continuous spiral. The single continuous spiral servo write format can be written quickly since the time consuming step-and-settle sequence required of concentric servo pattern writing is removed. Once the spiral information is written, servo operations for concentric tracks are done by adding a computed offset to each decoded servo position to yield a data track at a fixed radius.

In some embodiments, the servo wedge 128 will also include other information such as a wedge number. This can be a single bit to designate an index wedge (wedge #0), or the SAM may be replaced by another pattern (referred to as a servo index mark or SIM), or the wedge may contain a few low-order bits of the wedge number or a complete wedge number.

FIG. 2B is a graphic portrayal of the spiral servo pattern taken at representative locations within each revolution to yield a spiral servo pattern, according to an example embodiment. FIG. 2B is a representation of a servo signal as it appears in a wedge 0 at an index mark 290, a wedge w/4 (where w is the number of wedges around the disk) which is one quarter of a revolution from the index mark 290, a wedge w/2 that is written one half of a revolution from the index mark 290, and a wedge w3/4 that is three fourths of a revolution from the index mark 290. Also shown is a first representative concentric data track 291 and a second representative concentric data track 292. The concentric data tracks 291 and 292 are shown as straight lines for the sake of simplicity. In addition, there may be 100-150 servo wedges positioned around the disk, so the small arcuate portions are almost linear. The servo wedges 0, w/4, w/2, w3/4 include a quadrature pattern. The servo wedges 0, w/4, w/2, w3/4 also include a servo track number which is incremented each time the spiral passes the index mark 290. The servo track number associated with the spiral servo tracks are marked 2N0, 2N-1, 2N-2, and 2N-3.

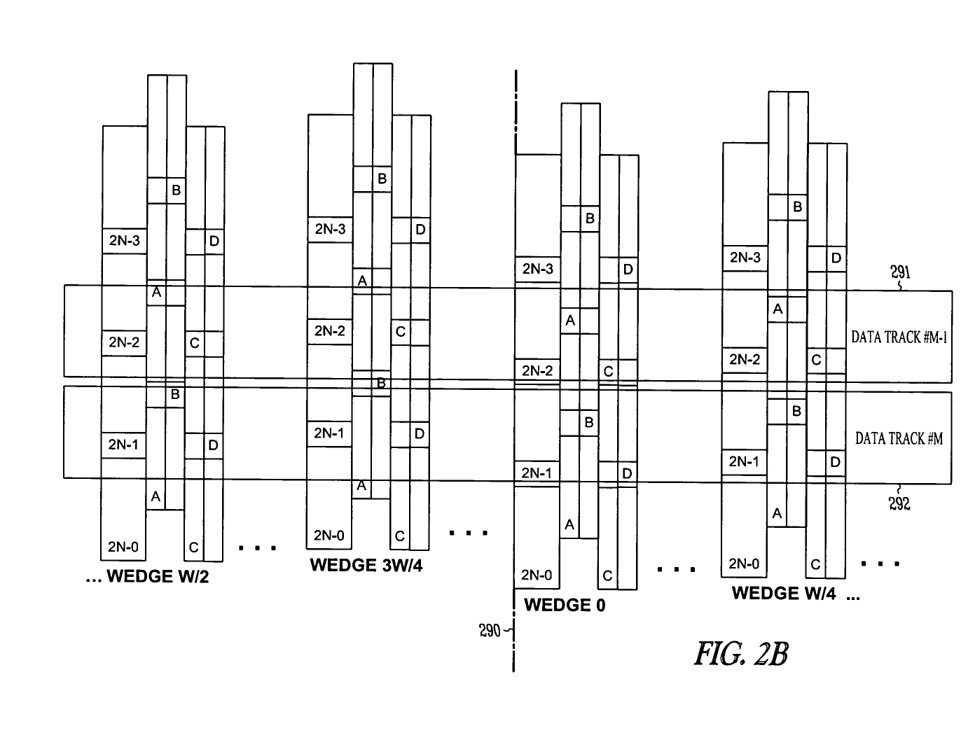

FIG. 3 is a representation of a servo signal that is written as a continuous spiral around the circumference of a disk, such as disk 120 (shown in FIG. 1), according to an example embodiment. FIG. 3 includes a first concentric track 300, a second concentric track 301, a third concentric track 302 and a fourth concentric track 303. Also illustrated in FIG. 3 are a plurality of servo wedges 310, 311, 312, 313, 318 and 319. Each of the servo wedges 310, 311, 312, 313, 318, 319 are depicted as a line that traverses or crosses the tracks 300, 301, 302, 303. Also illustrated in FIG. 3 is the spiral servo pattern as it moves with respect to a track. For example, the spiral servo pattern advances by approximately one-half a track width over N servo wedges. Therefore, knowing a number of servo wedges on the surface of the disk drive and assuming that these servo wedges are substantially equally spaced the amount of offset of the servo signal with respect to the track center line can be determined. For example, if a disk surface includes 100 different servo wedges 310 to 319 that are equally positioned around the circumference of the disk surface then the amount of offset of the servo signal from the actual track center can be determined. Referring to track number 303 and given the condition that there are 100 different servo wedges it can be seen that the servo signal depicted by line 323 is aligned with the track center at servo wedge 310 and is half a track off at wedge 319. If there are 100 servo wedges which are substantially equally spaced around the circumference of the disk the amount of offset at each servo wedge from the previous servo wedge will be 0.5% of the track width. After 100 servo wedges the spiral servo tracks 323 will have moved or be offset from the center of track 303 by half of a servo track. Track 302 has a similar servo pattern 322 that is offset by half a track over the circumference of the drive and track 301 has a servo signal 321 that starts on the track center at wedge 310 and is half a track off at wedge 319. As can be seen at a particular wedge such as wedge 319 the offset of the servo signal or servo signals such as 323, 322, and 321 from the respective tracks 303, 302, 301 are all the same. Therefore, for a particular servo wedge the offset will always be the same regardless of what track is to be followed. It should also be noted that when a transducing head flies over a particular wedge such as wedge 319, the offset will always be the same and the servo signal will always be under the same portion or region of the read head. Therefore, at each servo wedge regardless of the track number as long as the servo wedge is the same the versed signal will be positioned at the same offset from the center of the head. Also, it should be noted, by example but not limited to, that there are generally two burst signals or two servo signals in many of the servo schemes. These servo signals are represented by lines 321′, 322′, and 323′ in FIG. 3.

The disk drive 100 not only includes many mechanical features and a disk with a servo pattern thereon, but also includes various electronics for reading signals from the disk 120 and writing information representing data to the disk 120. FIG. 4 is a schematic diagram of a disk drive 100 that more fully details some of example electronic portions of the disk drive 100, according to an example embodiment. Referring to FIG. 4, the disk drive device 402 is shown as including a head disk assembly (HDA) 406, a hard disk controller (HDC) 408, a read/write channel 413, a microprocessor 410, a motor driver 422 and a buffer 424. The read/write channel 413 is shown as including a read/write path 412 and a servo demodulator 404. The read/write path 412, which can be used to read and write user data and servo data, may include front end circuitry useful for servo demodulation. The read/write path 412 may also be used for writing servo information in self-servowriting. It should be noted that the disk drive 100 also includes other components, which are not shown because they are not necessary to explain the example embodiments.

The HDA 406 includes one or more disks 120 upon which data and servo information can be written to, or read from, by transducers or transducing heads 146. The voice coil motor (VCM) 112 moves an actuator 130 to position the transducing heads 146 on the disks 110. The motor driver 422 drives the VCM 112 and the spindle motor (SM) 416. More specifically, the microprocessor 410, using the motor driver 422, controls the VCM 112 and the actuator 130 to accurately position the heads 146 over the tracks (described with reference to FIGS. 1-3) so that reliable reading and writing of data can be achieved. The servo fields 128, discussed above in the description of FIGS. 1-3, are used for servo control to keep the heads 146 on track and to assist with identifying proper locations on the disks 120 where data is written to or read from. When reading a servo wedge 128, the transducing heads 146 act as sensors that detect the position information in the servo wedges 128, to provide feedback for proper positioning of the transducing heads 146.

The servo demodulator 404 is shown as including a servo phase locked loop (PLL) 426, a servo automatic gain control (AGC) 428, a servo field detector 430 and register space 432. The servo PLL 426, in general, is a control loop that is used to provide frequency and phase control for the one or more timing or clock circuits (not shown in FIG. 4), within the servo demodulator 404. For example, the servo PLL 426 can provide timing signals to the read/write path 412. The servo AGC 428, which includes (or drives) a variable gain amplifier, is used to keep the output of the read/write path 412 at a substantially constant level when servo wedges 128 on one of the disks 120 are being read. The servo field detector 430 is used to detect and/or demodulate the various subfields of the servo wedges 128, including the SAM 204, the track number 206, the first phase servo burst 210, and the second phase servo burst 220. The microprocessor 410 is used to perform various servo demodulation functions (e.g., decisions, comparisons, characterization and the like), and can be thought of as being part of the servo demodulator 404. In the alternative, the servo demodulator 404 can have its own microprocessor.

One or more registers (e.g., in register space 432) can be used to store appropriate servo AGC values (e.g., gain values, filter coefficients, filter accumulation paths, etc.) for when the read/write path 412 is reading servo data, and one or more registers can be used to store appropriate values (e.g., gain values, filter coefficients, filter accumulation paths, etc.) for when the read/write path 412 is reading user data. A control signal can be used to select the appropriate registers according to the current mode of the read/write path 412. The servo AGC value(s) that are stored can be dynamically updated. For example, the stored servo AGC value(s) for use when the read/write path 412 is reading servo data can be updated each time an additional servo wedge 128 is read. In this manner, the servo AGC value(s) determined for a most recently read servo wedge 128 can be the starting servo AGC value(s) when the next servo wedge 128 is read.

The read/write path 412 includes the electronic circuits used in the process of writing and reading information to and from disks 120. The microprocessor 410 can perform servo control algorithms, and thus, may be referred to as a servo controller. Alternatively, a separate microprocessor or digital signal processor (not shown) can perform servo control functions.

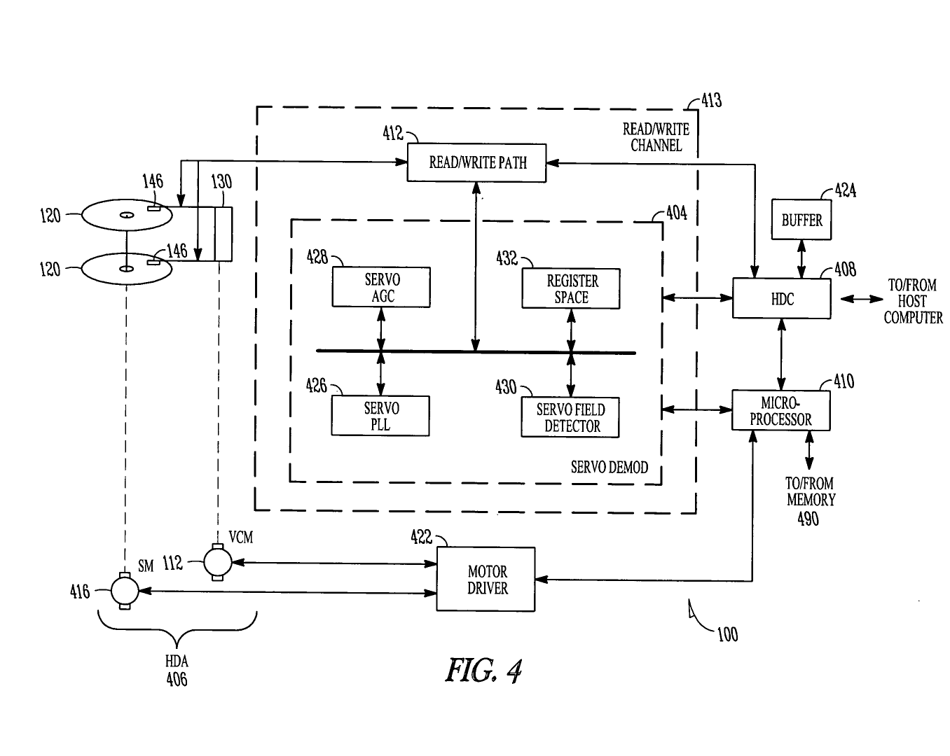

FIG. 5 is a schematic diagram showing portions of the read/write path 412 and the servo field detector 430 of FIG. 4, according to an example embodiment. Since the example embodiments relate to reading the servo bursts and processing the signals resulting from reading the servo bursts, the read portions of the read/write path 412 will now be further detailed. The read portion of path 412 is shown as including a variable gain amplifier (VGA) 512, which receives signals from transducing heads 146, or more likely from a pre-amplifier (not shown) driven by a signal received from transducing heads 146. In some embodiments, the VGA 512 may be external to the read/write path 412. During servo reading, the VGA 512 is at least partially controlled by the servo AGC 428. Additional amplifiers, such as buffer amplifiers and/or one or more additional VGAs may also be present. The read/write path 412 is also shown as including an analog filter/equalizer 514, a flash analog-to-digital (A/D) converter 516, a finite impulse response (FIR) filter 518 and a decoder 520. Alternatively, the FIR filter 518 can be upstream of the A/D converter 516, and FIR filtering can be performed using analog circuitry.

During servo reading, magnetic flux transitions sensed by the selected transducing head 146 are may be preamplified before being provided to the VGA 512, which controls amplification of an analog signal stream. The amplified analog signal stream is then provided to the analog filter/equalizer 514, which can be programmed to be optimized for the data transfer rate of the servo information being read by one of heads 146. The equalized analog signal is then subjected to sampling and quantization by the high speed flash A/D 516 which generates raw digital samples that are provided to the FIR filter 518. Timing for sampling can be provided by the servo PLL 426, as shown. Alternatively, sampling maybe performed asynchronously, e.g., using an asynchronous clock (in which case, most features of the present invention are still useful). The FIR filter 518 filters and conditions the raw digital samples before passing filtered digital samples to the decoder 520. The decoder 520 decodes the digital sample stream and outputs a binary signal. The servo PLL 426 can also provide other timing signals that are necessary for the path 412 and portions of the servo demodulator 404 to operate properly.

The binary signal output is provided to the servo field detector 430, and more specifically to a SAM detector 532 and a track number detector 534 of the servo field detector 430. The output of the FIR filter 518 is provided to a burst demodulator 536. Alternatively, the output of the flash A/D 516 can be provided to the burst demodulator 536. The SAM detector 532 searches for a SAM using, for example, pattern recognition logic that recognizes the SAM pattern within the binary stream. The SAM detector 532 can allow some fault or error tolerance, so that a SAM pattern will be detected even if one or more of the bits in the binary stream do not exactly match the SAM pattern. As a consequence, should minor errors occur in reading or writing the SAM patterns, it may still be possible to fully demodulate the information contained in the servo wedge 138. The track number detector 534 performs decoding of gray codes (if necessary) and detects track numbers. The burst demodulator 536 measures burst amplitudes and/or phases.

The position error signal (PES) is made up of many sources. Two major sources include non-repeatable runout (NRRO) and repeatable runout (RRO). The term ‘repeatable’ is the periodicity associated with each spindle revolution. The NRRO error is characterized as a signal that will not repeat and is caused by random outside disturbances (external vibration, air turbulence, etc). The RRO is errors that will repeat with each revolution, such as track eccentricity. A minor error term, associated with the transducing head, and more specifically the read element of a transducing head, is called the head non-linearity. The head non-linearity is due to the fact that the read element, such as a magnetoresistive (MR) read element or giant (GMR) read element, is not uniformly sensitive across its width. This distortion can be passively learned by the controlling software and is the basis of this invention.

Once the PES is determined, the value can be used as feedback in the control system to provide a signal to the voice coil motor of the actuator to either maintain the position of the transducing head over a desired track centerline or to reposition the transducing head to a position over the centerline of a desired track.

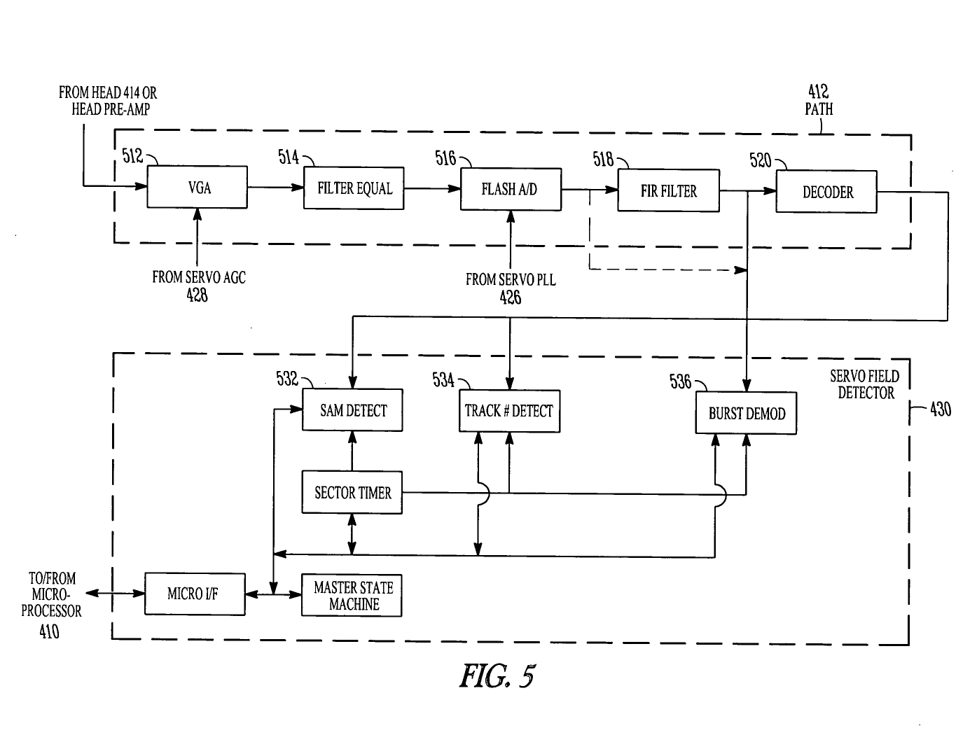

FIG. 6 is a model 600 of the disk drive system and a periodic error source 610. The model also can include a controller 620 and a plant 630. The controller 620 produces a drive signal for the actuator to move the head to an appropriate position so that it is centered over a track or a desired track. The measured burst offset is a process output designated by the reference numeral 631. The burst offset 631 is summed with the error term 610. As shown in FIG. 6, the error term 610 is dependent upon the burst value 610.

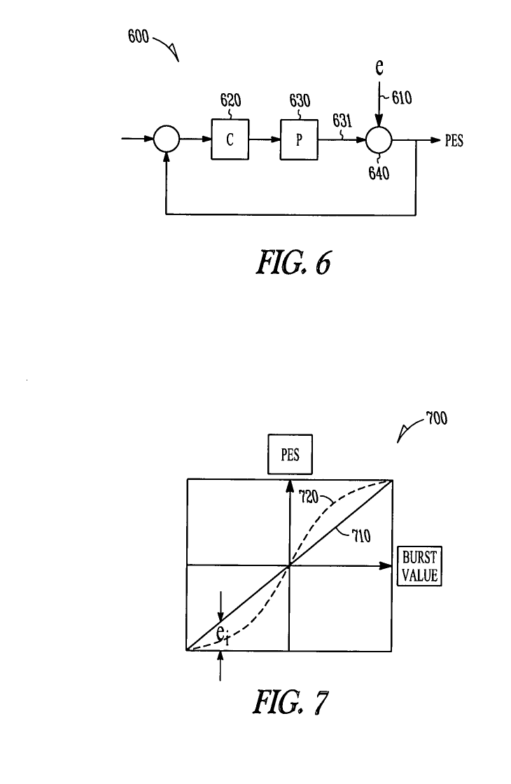

FIG. 7 is a look-up table 700 of the error term 610 as they vary from the ideal straight line (where y=x) as depicted by reference numeral 710. The actual head nonlinearity is depicted by the dotted line 720. The single point difference between the straight line 710 and the dotted line 720 is the error term for a particular burst value. When a burst value at a particular or selected wedge is read, the actual associated position is found in the look-up table 700. Thus, the burst non-linearity is corrected by the look-up table. The head non-linearity is corrected so that the control signal produced by the control loop will be not be distorted and allow the read head to more accurately follow the track on the disk.

During read/write operation, the read heads tend to stay at a concentric track for a selected amount of time. While on a concentric track, information is passively collected on a number of wedges per revolution of the disk. Each wedge in a spirally written servo pattern has a different offset on the servo spiral and represents a different index into the look-up table 700. The N wedges of information represent N regions in the table 700. Multiple revolutions are used on a multiple concentric track to minimize the effect of RRO and NRRO. Once enough data has been collected, the periodicity observed in position error is associated with each wedge on the spiral. For example, the position error term for wedge N−1, which carries the reference numeral 319, for all of tracks. The expected offset is removed from each of the burst value readings and any consistent error is then identified as due to the head non-linearity at that particular index into table 700. It is assumed that the spirals are written as straight lines. It is also assumed that all the coincentric tracks are in fact coincentric. If all of the tracks are concentric then there is no repeatable runout between the tracks and, therefore, the consistent error signal that remains is in fact due to the nonlinearity of the read element. This error term can then be used to correct the lookup table 700 as indexed by the average burst value observed for wedge N−1. By accounting for this error there will not be an error introduced by the head non-linearity in trying to drive the read element to a position over a particular track.

The periodic error signal 610 cannot be measured directly; it must be computed knowing the dynamics of the servo loop. The only visible signals are the burst values observed from the read element. The burst values are the system's response to all the previous error terms and external disturbances seen by the system in the past. To compute the periodic error signal 610, we must aggregate a collection of N representative periodic PES terms and calculate what the N periodic error signals must have been to yield those PES terms. This could be done via an N×N matrix inversion but, in this case, some simplification can be done. Mathematically, the various errors associated with the different location along a servo wedge can be represented as

$$pes = [ \begin{matrix}{pes}_{1} \\ {pes}_{2} \\ {pes}_{3} \\ \cdot \\ {pes}_{n - 2} \\ {pes}_{n - 1} \\ {pes}_{n}\end{matrix} ]$$

Assuming the spiral is straight, the position errors observed are caused by consistent errors in the look-up table.

$$e = [ \begin{matrix}{e}_{1} \\ {e}_{2} \\ {e}_{3} \\ \cdot \\ {e}_{n - 2} \\ {e}_{n - 1} \\ {e}_{n}\end{matrix} ]$$

The system is:

$$pes = \frac{e}{( 1 + CP )}$$

Or expressed as:

pes\textcircled{x}(1+CP)=e

Where, \textcircled{x} is the circular convolution operator. The system (1+CP) is the inverse of the error transfer function and is measured and solved by using selected frequencies techniques available in the literature. The average wedge-by-wedge PES across many tracks is assumed to have no repeatable error. The errors solved for in this application are not errors in the written trajectory but errors in the PES linearity table, indexed wedge-by-wedge.

The error terms are used to update the look-up table(s). Seeks are conducted to another track and the measurement and use those error terms is repeated to update the tables. This process is continued at other locations to generate representative PES linearization table(s) across the stroke.

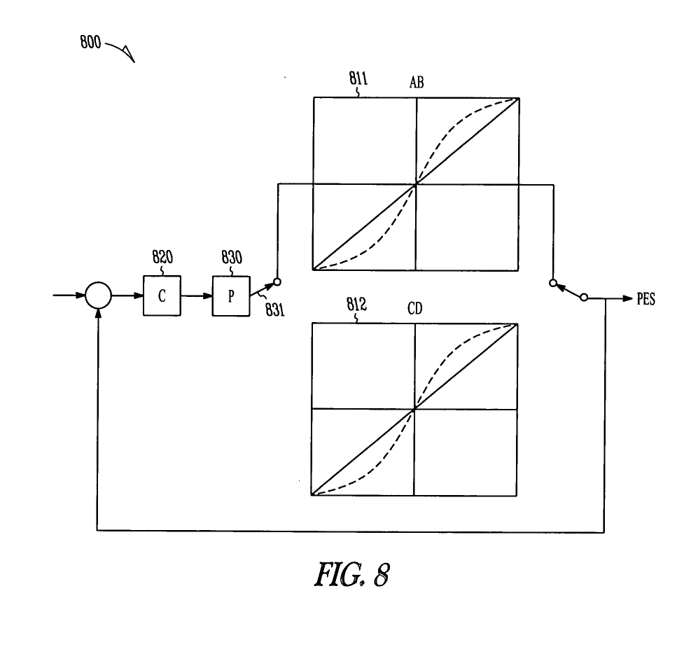

FIG. 8 is a model 800 of a disk drive system and an error source, according to an example embodiment. The system is a closed control loop system that includes a controller 820, a plant 830 and a control loop. The servo position is decoded through reading multiple of bursts and taking combinations and/or differences of the burst values. The plant influences the burst value as depicted by reference numeral 831, which is corrected by a table look-up as in FIG. 7. In the example, the table look-up 811 is for an AB quadrature type servo where there are two sets of burst pairs. When the burst value is associated with a CD burst, the burst value 831 from the plant 830 is switched to table look-up 812. The actual burst offset value 831 is corrected with a look-up from table 811 or from table 812 to produce the actual position error signal. The actual position error signal is fed back to a summer which is in turn fed back into the drive signal going into the controller 820.

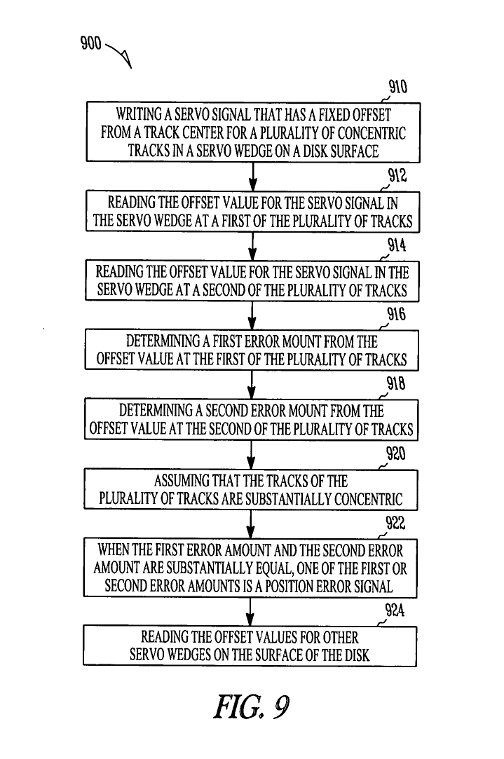

FIG. 9 is a flow diagram of a method 900 for determining a position error signal in a disk drive, according to an example embodiment. The method 900 for determining a position error signal in a disk drive includes writing a spiral servo signal that has a varying offset from a track center for a plurality of concentric tracks for the servo wedges on a disk surface 910, observing the offset values for the servo signal in the servo wedges at a first of the plurality of tracks 912, and observing the offset values for the servo signal in the servo wedges at a second of the plurality of tracks 914. The method also includes determining a first error amount from the offset values at the first of the plurality of tracks 916, and determining a second error amount from the offset values at the second of the plurality of tracks 918. The method 900 also includes assuming that the tracks of the plurality of tracks are substantially concentric 920. This leads to the conclusion that the consistent errors in the offset values as read by the read element are due to non-linearity of the read element of the sensing head.

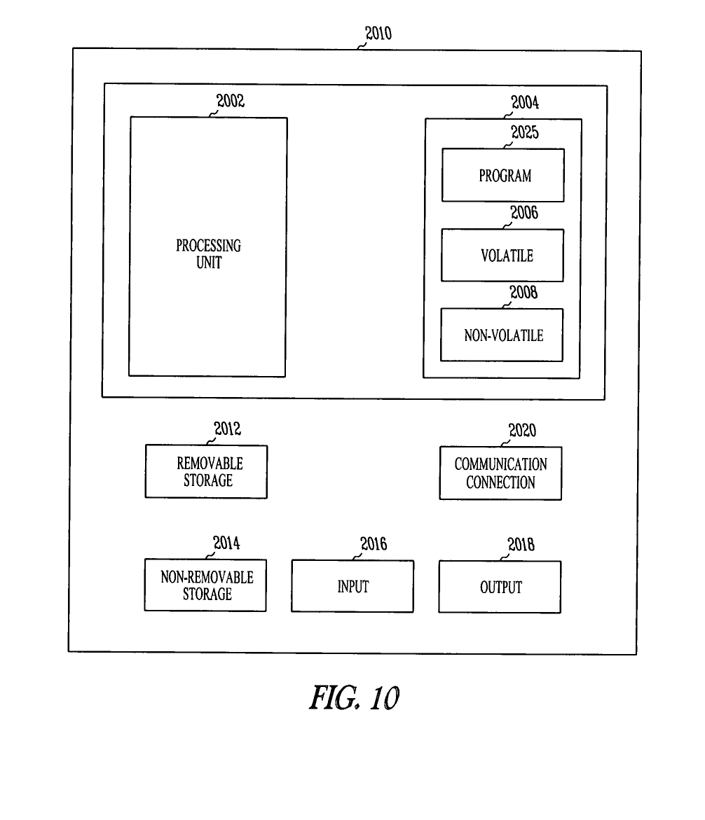

A block diagram of a computer system that executes programming for performing the above algorithm is shown in FIG. 10. A general computing device, in the form of a computer 2010, may include a processing unit 2002, memory 2004, removable storage 2012, and non-removable storage 2014. Memory 2004 may include volatile memory 2006 and non volatile memory 2008. Computer 2010 may include—or have access to a computing environment that includes—a variety of computer-readable media, such as volatile memory 2006 and non-volatile memory 2008, removable storage 2012 and non-removable storage 2014. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 2010 may include or have access to a computing environment that includes input 2016, output 2018, and a communication connection 2020. The computer may operate in a networked environment using a communication connection to connect to one or more remote computers. The remote computer may include a personal computer (PC), server, router, network PC, a peer device or other common network node, or the like. The communication connection may include a Local Area Network (LAN), a Wide Area Network (WAN) or other networks. The microprocessor 210 or other selected circuitry or components of the disk drive may be such a computer system.

Computer-readable instructions stored on a computer-readable medium are executable by the processing unit 2002 of the computer 2010. A hard drive, CD-ROM, and RAM are some examples of articles including a computer-readable medium. Other machine readable media include a connection to a server via an internet connection to a web site. The machine-readable medium provides instructions that, when executed by a machine, cause the machine to perform operations including reading the offset value for the servo signal in the servo wedge at a first of the plurality of tracks, reading the offset value for the servo signal in the servo wedge at a second of the plurality of tracks, determining a first error amount from the offset value at the first of the plurality of tracks, and determining a second error amount from the offset value at the second of the plurality of tracks. If the first error amount and the second error amount are substantially equal, one of the first or second error amounts is used as a position error signal. The instructions, when executed by a machine, may also cause the machine to read the offset value for the servo signal in a plurality of servo wedges at a first track of the plurality of tracks. The instructions, when executed by a machine, cause the machine to place one of the first error amount or the second error amount in a look-up table indexed by the burst offset signal. The instructions also cause the machine to add one of the first error amount or the second error amount to a burst offset signal.

A disk drive 100 includes a plurality of concentric tracks, a first servo wedge 310 written with a continuous spiral pattern, and a second servo wedge written with the continuous spiral pattern 311. The first servo wedge 310 and the second servo wedge 311 traverse the plurality of tracks 300, 301, 302, 303. The disk drive 100 also includes a memory 490 that stores a plurality of offset values related to a plurality of track positions with respect to the first servo wedge at a plurality of tracks 700, 800, and an apparatus for comparing the offset value as read to an expected offset value for a plurality of tracks related to the first servo wedge. When the difference between the offset value as read and the expected offset value for a first track is substantially equal to the difference between the offset value as read and the expected offset value for a second track then the difference between the offset value as read and the expected offset value for one of the first track and the second track is a position error signal for a read element. The read element detects and obtains an actual offset value which is in error by an amount equal to the position error signal. The memory 490 stores the position error signal for the first servo wedge as related to the plurality of tracks. The memory 490 also stores the position error signal for the second servo wedge as related to the plurality of tracks. The memory 490 also includes a table look-up relating the values of a burst offset signal as read to a position error signal. The disk drive 100 also includes a device for updating the look-up table. In one embodiment, the memory includes a first table look-up 811 relating the values of an AB burst offset signal as read with a position error signal, and a second table look-up 812 relating the values of a CD burst offset signal as read with a position error signal. The disk drive 100 may also include a device for updating the first look-up table and the second look-up table.

The foregoing description of the specific embodiments reveals the general nature of the invention sufficiently that others can, by applying current knowledge, readily modify and/or adapt it for various applications without departing from the generic concept, and therefore such adaptations and modifications are intended to be comprehended within the meaning and range of equivalents of the disclosed embodiments.

It is to be understood that the phraseology or terminology employed herein is for the purpose of description and not of limitation. Accordingly, the invention is intended to embrace all such alternatives, modifications, equivalents and variations as fall within the spirit and broad scope of the appended claims.

What is claimed is:

1. A method for determining a position error signal in a disk drive comprising:
writing a servo signal that has a variable offset from a track center for a plurality of concentric tracks in a servo wedge on a disk surface thus forming a spiral servo signal;
reading the offset value for the servo signal in the servo wedge at a first of the plurality of tracks;
reading the offset value for the servo signal in the servo wedge at a second of the plurality of tracks;
determining a first error amount from the offset value at the first of the plurality of tracks; and
determining a second error amount from the offset value at the second of the plurality of tracks, and if the first error amount and the second error amount are equal, using one of the first or second error amounts to update a head linearity look-up table.

2. The method of claim 1 further comprising reading the offset values for other servo wedges on the surface of the disk.

3. The method of claim 2 wherein the offset values for other servo wedges are different than the first servo wedge.

4. The method of claim 1 wherein writing the servo signal includes writing a spiral signal.

5. The method of claim 1 wherein writing the servo signal includes writing a single continuous spiral.

6. The method of claim 1 wherein reading the offset value for the servo signal in the servo wedge at a first of the plurality of tracks, and reading the offset value for the servo signal in the servo wedge at a second of the plurality of tracks is repeated so as to substantially eliminate any non-repeatable component of the first error amount or the second error amount.

7. The method of claim 1 further comprising assuming that the tracks of the plurality of tracks are substantially concentric.

8. The method of claim 1 further comprising assuming that when the difference between the first error amount and the second error amount are substantially equal, one of the first error amount and the second error amount is due to nonlinearity of a read element.

9. A disk drive comprising:
a plurality of concentric tracks;
a first servo wedge written with a continuous spiral pattern, the first servo wedge traversing the plurality of tracks; and
a second servo wedge written with the continuous spiral pattern, the second servo wedge traversing the plurality of tracks; and
a memory to store a plurality of offset values related to a plurality of track positions with respect to the first servo wedge at a plurality of tracks;
an apparatus to compare the offset value as read to an expected offset value for a plurality of tracks related to the first servo wedge.

10. The disk drive of claim 9 wherein when the difference between the offset value as read and the expected offset value for a first track is substantially equal to the difference between the offset value as read and the expected offset value for a second track, then the difference between the offset value as read and the expected offset value for one of the first track and the second track is a position error signal for a read element that to obtain the actual offset values.

11. The disk drive of claim 10 further comprising a memory to store the position error signal for the first servo wedge as related to the plurality of tracks.

12. The disk drive of claim 10 further comprising a memory to store the position error signal for the first servo wedge as related to the plurality of tracks, and to store the position error signal for the second servo wedge as related to the plurality of tracks.

13. The disk drive of claim 9 wherein the memory comprises a table look-up relating the values of a burst offset signal as read with a position error signal.

14. The disk drive of claim 13 further comprising a device to update the look-up table.

15. The disk drive of claim 9 wherein the memory further comprises:
a first table look-up relating the values of an AB burst offset signal as read with a position error signal; and
a second table look-up relating the values of an CD burst offset signal as read with a position error signal.

16. The disk drive of claim 15 further comprising a device to update the first look-up table and the second look-up table.

17. A machine-readable medium that provides instructions that, when executed by a machine, cause the machine to:
read the offset value for the servo signal in the servo wedge at a first of the plurality of tracks;
read the offset value for the servo signal in the servo wedge at a second of the plurality of tracks;
determine a first error amount from the offset value at the first of the plurality of tracks; and
determine a second error amount from the offset value at the second of the plurality of tracks, and if the first error amount and the second error amount are equal, using one of the first or second error amounts as a position error signal.

18. The machine readable medium of claim 17 wherein the instructions, when executed by a machine, cause the machine to read the offset value for the servo signal in a plurality of servo wedges at a first track of the plurality of tracks.

19. The machine readable medium of claim 17 wherein the instructions, when executed by a machine, cause the machine to place one of the first error amount or the second error amount in a look-up table indexed by the burst offset signal.

20. The machine readable medium of claim 17 wherein the instructions, when executed by a machine, cause the machine to add one of the first error amount or the second error amount to a burst offset signal.
